(19) United States
(12) Patent Application Publication
(10) Pub. No.: US 2023/0212941 A1
(43) Pub. Date: Jul. 6, 2023

(54) VISIBLE/IR CAMERA-BASED MULTI-PHASE FLOW SENSOR FOR DOWNHOLE MEASUREMENTS IN OIL PIPES

(71) Applicant: CALIFORNIA INSTITUTE OF TECHNOLOGY, Pasadena, CA (US)

(72) Inventors: Mathieu FRADET, PASADENA, CA (US); Ryan M. BRIGGS, PASADENA, CA (US); Linda Y. DEL CASTILLO, TUSTIN, CA (US); Mina RAIS-ZADEH, PASADENA, CA (US)

(21) Appl. No.: 17/999,138

(22) PCT Filed: Jun. 11, 2021
(86) PCT No.: PCT/US2021/036935

§ 371 Date: Nov. 17, 2022

Related U.S. Application Data
(60) Provisional application No. 63/039,591, filed on Jun. 16, 2020.

(51) Int. Cl. E21B 47/113; E21B 47/017

(52) U.S. Cl. CPC E21B 47/114; E21B 47/0175

(57) ABSTRACT

Systems and methods for measuring flow velocity of a fluid mixture in a lateral section of an oil/gas well are presented. The flow velocity is measured by tracking movement of particles and/or features in the fluid mixture via visible and/or infrared imaging sensors of a camera-based flow sensor. According to another aspect, the imaging sensors detect back-reflected light by the particles and/or features, the light emitted by illuminators in the visible and/or infrared spectrum. According to yet another aspect, the particles are quantum dot illuminators injected into the fluid mixture, the flow velocity based on a time-of-flight of the quantum dots. The camera-based flow sensor may be rotatable to measure flow velocities at different angular positions of a pipe, rotation provided by rotation of an element of a mobile vessel to which the flow sensor is rigidly coupled.

### CROSS REFERENCE TO RELATED APPLICATIONS

The present application claims priority to and the benefit of co-pending U.S. provisional patent application Ser. No. 63/039,591 entitled “Infrared/Visible Optical Flow Sensor for Multi-Phase Mixtures”, filed on Jun. 16, 2020, the disclosure of which is incorporated herein by reference in its entirety.

### TECHNICAL FIELD

The present disclosure generally relates to systems and methods for measuring fluid flow rate in fluid mixtures, such as, for example, mixtures of oil, water and gas found in lateral oil/gas wells.

### BACKGROUND

Detailed information about physical properties (e.g., reservoir inflow) in the downhole of an oil-gas producing well, is important to help optimize production and field development. Inflow data points such as oil-gas-water flow rates, pressure, and temperature, for example, are key to understanding the nature of the reservoir properties and the effect of well drilling and completion methods. Although useful, the inflow data are not often measured in real-time, or with considerable frequency (weekly or more frequently), along the lateral section of the well due to technical or cost-prohibitive challenges. Instead, surface well-head production data (total flow rates, pressure, temperature, etc.) are measured for well performance diagnostics and for reporting purposes.

Attempts to instrument the well for real time or at least weekly measurements with continuous electrical or fiber optic cables for powering sensors to measure and deliver physical properties in the downhole of a well have been tested and have not been cost effective. This is particularly true for shale and tight development wells that have, for example, long laterals and multiple perforation entry points of their casing pipe (to contact the rock formation) which then undergo high-pressure hydraulic fracturing to increase hydrocarbon inflows from oil-bearing rock formations. Such harsh activities can easily damage not only the sensors but also power and data cables in the downhole of a well.

Production-logging tools (PLTs) are used routinely within long, horizontal wells to make measurements of local pressure, temperature, composition and flow rates. PLTs, however, are provided as a service and require well intervention for data to be collected; the operational cost and complexity limiting the frequency the data can be collected within a well.

Unconventional tight rock geologic formations may require a large number of oil/gas wells (holes) drilled in close proximity to each other to effectively extract the hydrocarbon contained in a field. Horizontally-drilled wells may be used in these applications since the hydrocarbon-bearing rock formations tend to exist in stratified layers aligned perpendicular to the gravity vector.

The typical vertical section of these wells can be 1-3 km below the surface and can extend laterally (e.g., in a generally horizontal direction) for distances of, for example, 2-3 km or even more. Oil, natural gas, and water may enter the well at many locations (production intervals/zones open to perforations and fracturing) formed along a lateral distance (e.g., 2-3 km or more) of the well with local flow rates and composition (e.g. oil/water fractions) varying due to inherent geology and the accuracy with which the well intersects (e.g., at the production intervals or sections) the oil-bearing rock formations. In general, information about the performance or hydrocarbon delivery and capacity of a well, such as, for example, flow rate, pressure, and composition, can practically be measured at the surface of the well as-combined values and with little or no knowledge of individual contributions from each of the production intervals or zones. Lack of local information of the inflow details of the well, at, for example, the production intervals or zones, can be a barrier to improving the efficiency of oil-gas extraction from the overall field.

Better knowledge of local interval inflow data across each or multiple entry points (e.g. physical properties such as flow rates, pressure, temperature, etc.) at the downhole of a well (e.g., along the horizontal/lateral section of the well) may help in making better decisions about placement of subsequent perforation/completion intervals for production in a well and/or subsequent drilling of other wells in the field.

For example, an oil production field may have a variety of drilled wells, including an unconventional horizontal oil well that extracts oil from shale and tight formation through a plurality of production intervals or zones (shown as rectangles). In order to develop the field, producing the hydrocarbon-bearing rock formations, a number of wells (i.e., holes) may be drilled and spaced, for example, in the order of 500 feet apart from each other. These wells are drilled and completed serially so that information may be gathered from a downhole of a first well, for example, and can aid in determining where to perforate the casing and to apply hydraulic fracturing at selected intervals of the formation in a second and following well.

### SUMMARY

Although the present systems and methods are described with reference to wells used in the oil industry, such systems and methods may equally apply to other industries, such as, for example, deep sea exploration or through-ice exploration. Furthermore, although the present systems and methods are described with reference to oil-gas-water mixtures found in oil wells, such systems and methods may equally apply to any other fluid mixtures.

According to one embodiment the present disclosure, a system for gathering information about physical properties in a lateral section of a well is presented, the system comprising: a mobile vessel configured for submersion into a fluid mixture of the lateral section of the well; and a camera-based flow sensor attached to the mobile vessel, the camera-based flow sensor comprising: a camera system configured to capture images in a visible spectrum and in an infrared spectrum; and an illuminator system configured to emit light in the visible spectrum and in the infrared spectrum, wherein the camera-based flow sensor is configured to emit light into the fluid mixture and capture images of back-reflected light from features present in the fluid mixture.

According to a second embodiment of the present disclosure, a system for gathering information about physical properties in a lateral section of a well is presented, the system comprising: a mobile vessel configured for submersion into a fluid mixture of the lateral section of the well; and a camera-based flow sensor attached to the mobile vessel, the camera-based flow sensor comprising: a quantum dot illuminator system comprising a plurality of quantum dot illuminators configured to emit light in the visible spectrum, the quantum dot illuminator system configured to release a group of quantum dot illuminators of the plurality of quantum dot illuminators into the fluid mixture; and a first camera system configured to capture a first image of light emitted by the at least one quantum dot illuminator through the fluid mixture.

According to a third embodiment of the present disclosure, a camera-based flow sensor is presented, the camera-based flow sensor comprising: a camera system configured to capture images in a visible spectrum and in an infrared spectrum; and an illuminator system configured to emit light in the visible spectrum and in the infrared spectrum, wherein the camera-based flow sensor is configured to emit light into a fluid mixture and capture images of back-reflected light from features present in the fluid mixture.

According to a fourth embodiment of the present disclosure, a camera-based flow sensor is presented, the camera-based flow sensor comprising: a quantum dot illuminator system comprising a plurality of quantum dot illuminators configured to emit light in the visible spectrum, the quantum dot illuminator system configured to release a group of quantum dot illuminators of the plurality of quantum dot illuminators into a fluid mixture; and a camera system configured to capture a first image of light emitted by the group of quantum dot illuminators through the fluid mixture.

According to a fifth embodiment of the present disclosure, a method for measuring a flow velocity of a fluid mixture is presented, the method comprising: emitting a light into the fluid mixture; based on the emitting, capturing a sequence of consecutive images of back-reflected light from features present in the fluid mixture; and based on the capturing, determining the flow velocity based on relative movement of the features within the sequence of consecutive images.

According to a sixth embodiment of the present disclosure, a method for measuring a flow velocity of a fluid mixture is presented, the method comprising: releasing a group of quantum dot illuminators into the fluid mixture; based on the releasing, capturing a first image of light emitted by the group of quantum dot illuminators through the fluid mixture; determining a lapsed time between the releasing and the capturing; based on the determining, and based on a distance between a release position of the group of quantum dot illuminators and a position of a field of view of the first image, determining a time-of-flight of the group of quantum dot illuminators; and based on the determining of the time-of-flight, determining the flow velocity

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a cross sectional view of an example known oil production field, comprising one or more drilled wells for production of oil and/or gas in which a mobile vessel constructed in accordance with this disclosure may be disposed.

FIG. 2 shows a lateral section of a well of the oil production field shown in FIG. 1 comprising a plurality of production zones in which a mobile vessel constructed in accordance with this disclosure may be used.

FIG. 3 shows an example embodiment of a mobile vessel comprising a camera-based flow sensor according to the present disclosure, the mobile vessel positioned in a lateral section of a well of the oil production field shown in FIG. 1.

FIG. 4A shows a front view of the mobile vessel of FIG. 3 with the camera-based flow sensor positioned at a first angular position.

FIG. 4B shows a front view of the vessel of FIG. 3 with the camera-based flow sensor positioned at a second angular position.

FIG. 4C shows a camera-based flow sensor according to an embodiment of the present disclosure for simultaneous measurement of flow rate at a plurality of angular positions.

FIG. 5A shows details of a cross sectional front view of the camera-based flow sensor according to an embodiment of the present disclosure.

FIG. 5B shows details of a cross sectional side view of the camera-based flow sensor according to an embodiment of the present disclosure.

FIG. 6 shows a graph representative of a performance of an example CMOS imaging sensor used in the camera-based flow sensor according to the present disclosure.

FIG. 7 shows a block diagram according to an embodiment of the present disclosure of the camera-based flow sensor of FIG. 5A and FIG. 5B.

FIG. 8A shows details of a cross sectional side view of a camera-based flow sensor according to another embodiment of the present disclosure that is based on the camera-based flow sensor of FIG. 5A and FIG. 5B.

FIG. 8B shows details of a cross sectional side view of a camera-based flow sensor according to another embodiment of the present disclosure that is based on the camera-based flow sensor of FIG. 8A.

FIG. 8C shows details of a cross sectional side view of a camera-based flow sensor according to another embodiment of the present disclosure that is based on the camera-based flow sensor of FIG. 8B.

FIG. 9 shows a block diagram according to an embodiment of the present disclosure of the camera-based flow sensor of FIG. 8C.

FIG. 10A shows the mobile vessel of FIG. 3 within a casing pipe of a lateral well, the camera-based flow sensor arranged in a nose of the mobile vessel.

FIG. 10B shows the mobile vessel of FIG. 3 within a casing pipe of a lateral well, the camera-based flow sensor arranged in a main body of the mobile vessel.

FIG. 10C shows an example embodiment of another mobile vessel comprising the camera-based flow sensor according to the present disclosure.

Like reference numbers and designations in the various drawings indicate like elements.

### Definitions

As used herein the term “flow velocity” of a fluid may refer to the motion of the fluid per unit of time and may be represented locally by a corresponding “fluid velocity vector”. As used herein, the term “flow rate” of a fluid may refer to a volume of the fluid flowing past a point per unit of time. Therefore, considering a cross-sectional area of a flow of fluid, such as a flow of fluid through a lateral section of an oil well, the flow rate through the cross-sectional area can be provided by the flow velocity at that area.

As used herein the term “flow meter” may refer to a system that that is calibrated to provide a precise measurement of the flow velocity based on signals sensed by a flow sensor.

As used herein the term “infrared”, “infrared light” and “infrared emission” are synonymous and may refer to an electromagnetic radiation (EMR) with wavelengths in a range from about 780 nanometers to 1 millimeter and longer than those of visible light. As used herein the term “near infrared”, “near infrared light” and “near infrared emission” are synonymous and may refer to an electromagnetic radiation (EMR) with wavelengths in a range from about 780 nanometers to 3,000 nanometers.

As used herein the term “visible”, “visible light” and “visible emission” are synonymous and may refer to an electromagnetic radiation (EMR) with wavelengths in a range from about 380 nanometers to about 780 nanometers. Electromagnetic radiation in this range of wavelengths is visible to the human eye.

### DETAILED DESCRIPTION

As set forth above, information may be gathered from a downhole of a first well, for example, and can aid in determining where to perforate the casing and to apply hydraulic fracturing at selected intervals of the formation in a second and following well. Other useful information that may be collected within a well includes, by way of non-limiting example, fluid flow rates/velocities. Certain sensors for measuring flow rates (velocity) in an oil well are based on spinners (e.g., impellers) that rotate with angular speeds as a function of incident flow rates. When considering an oil-water-gas-sand environment as provided in a lateral section of a well, spinner technology is challenged primarily for its robustness and longevity within the environment. This includes difficulties with calibration and survivability incited by moving parts of the spinner-based sensors in a downhole environment, especially when considering operation over a length of months and/or years.

Teachings according to the present disclosure, among other technical advantages, solve the prior art shortcomings by providing a camera-based flow sensor configuration that may be considered as a “solid state” solution with the ability of measuring flow velocity profiles with greater accuracy while operating unattended for extended periods of time. When integrated with a mobile vessel, the flow sensor according to the present teachings may measure flow velocities of a fluid mixture of the downhole under a wide range of thermodynamic conditions, including at downhole pressures greater than 5000 psi, accurately and efficiently.

According to some embodiments of the present disclosure, the camera-based flow sensor may include a dual imaging sensor camera capable of resolving/capturing features in the fluid mixture that emit or reflect light in the visible and/or in the near infrared spectrum. Such features may correspond to any change in contrast present in the fluid mixture which the flow sensor can detect and track with the camera. Relative movement/position of the features in consecutive captured images (frames) and the rate of the capturing of the images (frame rate) allow determination of velocity of the features in the fluid mixture, and therefore of the fluid mixture (e.g., since the features can be assumed in equilibrium with the fluid mixtures). The frame rate may be selected in view of a target range of measurement velocities.

According to some embodiments of the present disclosure, the camera-based flow sensor can be controlled/configured for operation in the visible and/or in the infrared spectrum. For example, in a case where phases present in the fluid mixture in a field of view of the camera is not known, operation according to the visible and infrared spectrum can be multiplexed so to broaden the detection spectrum (e.g., sequence of images/frames captured with alternated spectrum). Alternatively, the camera can be controlled for simultaneous operation according to the visible and infrared spectrum so to broaden the detection spectrum and to increase resolution of the detection (e.g., sequence of images/frames each captured with broadened spectrum). On the other hand, in a case where a phase present in the fluid mixture in the field of view of the camera is known (e.g., via specific composition sensors in the mobile vessel), operation of the camera can be controlled based on an (a priori known) absorption spectrum of the phase. For example, while the absorption spectrum of oil includes a region of high absorption across the visible spectrum, it includes a region of low absorption (e.g., increased transmission) in a wavelength range between 1500 nm and 1700 nm, e.g. near 1600 nm, that is part of the near infrared spectrum. Accordingly, for sensing velocity in oil, the flow sensor according to the present disclosure may, in certain embodiments, be controlled to operate in the infrared spectrum.

According to some embodiments of the present disclosure, the changes in contrast detectable by the flow sensor may be based on back-reflected light from particles in the fluid or the fluid itself. In cases where the field of view of the camera includes multiple phases of the fluid mixture, the change in contrast may be based on back-reflected light from the interface between two phases (e.g., where gas and oil meet or where oil and water meet) of the fluid mixture. According to some embodiments of the present disclosure, the back-reflected light may be based on one or more illuminators (e.g., light sources/emitters, illumination sources/emitters) included in the flow sensor. According to an example embodiment, two illuminators may be provided: a visible spectrum illuminator for emitting light in the visible spectrum; and an infrared (e.g., near infrared) spectrum illuminator for emitting light in the infrared spectrum. During operation of the camera-based flow sensor in the visible spectrum, the visible spectrum illuminator may be enabled, and during operation of the camera-based flow sensor in the infrared spectrum, the infrared spectrum illuminator may be enabled. Each of the two illuminators may be arranged relative to the camera so to illuminate the field of view of the camera.

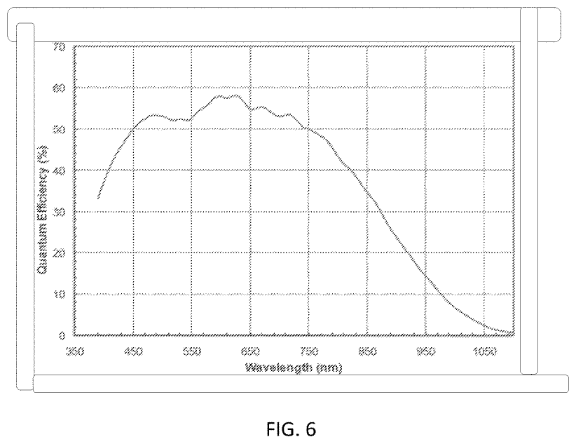

In some cases, the fluid mixture may include phases that include absorption spectra with peaks in the emission spectra of the illuminators included in the camera-based flow sensor. In other words, the fluid mixture may absorb a substantial portion of the (emitted) illumination such that no back-reflected light may be detected by the imaging sensors of the camera. It follows that according to an embodiment of the present disclosure, the flow sensor may inject light emitting particles (e.g., quantum dot illuminators) into the fluid mixture that can emit at wavelengths outside the peaks of the absorption spectra of the phases of the fluid mixture, and therefore can be detected and tracked by the camera-based sensor. An emission spectrum/wavelength of such quantum dot illuminators may be selected based on a quantum efficiency of either one of the two imaging sensors used in the camera-based sensor so to increase detection efficiency. According to a nonlimiting embodiment of the present disclosure, the emission spectrum/wavelength of the quantum dot illuminators may be in the visible spectrum. According to a nonlimiting embodiment of the present disclosure, the emission wavelength of the quantum dots may be in a range from 450 nm to 750 nm, corresponding to a region of high quantum efficiency of an imaging sensor represented by the graph of FIG. 6 later described.

Once injected into the fluid mixture, a quantum dot illuminator, or a cluster/group of quantum dot illuminators, may travel through the fluid mixture with the flow of the fluid mixture and therefore with a velocity that corresponds to the velocity of the fluid. According to an example embodiment of the present disclosure, the velocity of the fluid can be determined by establishing a time-of-flight (TOF) of the quantum dot illuminator (or cluster/group of dots) between its position when injected into the fluid, to its position in (a region of) a frame captured by the camera system. In some embodiments, and to reduce effects of flow perturbation, the time-of-flight may be based on a travel distance of the quantum dot illuminator of 10 cm or more. Further accuracy in the determination of the velocity can be provided via provision of one or more additional camera-based flow sensors arranged at different distances from one another so to determine the (fluid) velocity from a plurality of time-of-flights (e.g., from injection to first camera, from first camera to second camera, etc.).

According to an embodiment of the present disclosure, the quantum dots may be particles or nanocrystals of a semiconducting material in the range of 2-10 nm in diameter. These particles can be composed of a single material, a core material with shell of a different composition, or an alloy. Emission wavelengths of such quantum dots may be changed by modifying their composition while keeping their size constant. This allows to select an emission wavelength that can be detected from the camera-based flow sensor while reducing absorption through the fluid mixture, including in a region of a single phase (e.g., crude oil).

According to an example embodiment of the present disclosure, the quantum dots may be CdSₓSe₁₋ₓ/ZnS (CdSe core and ZnS shell) alloyed quantum dots with a size of about 6 nm. Such CdSₓSe₁₋ₓ/ZnS quantum dots may be held in suspension in Toluene contained within a reservoir for injection into the fluid mixture as bubbles. An emission wavelength of the CdSₓSe₁₋ₓ/ZnS quantum dots may be in a range from 610 nm to 630 nm.

According to an example embodiment of the present disclosure, the camera-based flow sensor can operate in: a) a reflective mode that detects back-reflected light from particle/features in the fluid mixture illuminated by light emitted from the illuminators; b) a transmissive mode that detects light emitted by injected quantum dot illuminators and transmitted through the fluid mixture, or c) a combination of a) and b). For cases wherein operation only according to the reflective mode is desired, implementation of the camera-based flow sensor may not include support for storage and ejection of the quantum dot illuminators. For cases wherein operation only according to the transmissive mode is desired, implementation of the camera-based flow sensor can be simplified by providing a camera system with a single imaging sensor (e.g., operating in the visible spectrum) and no illuminators.

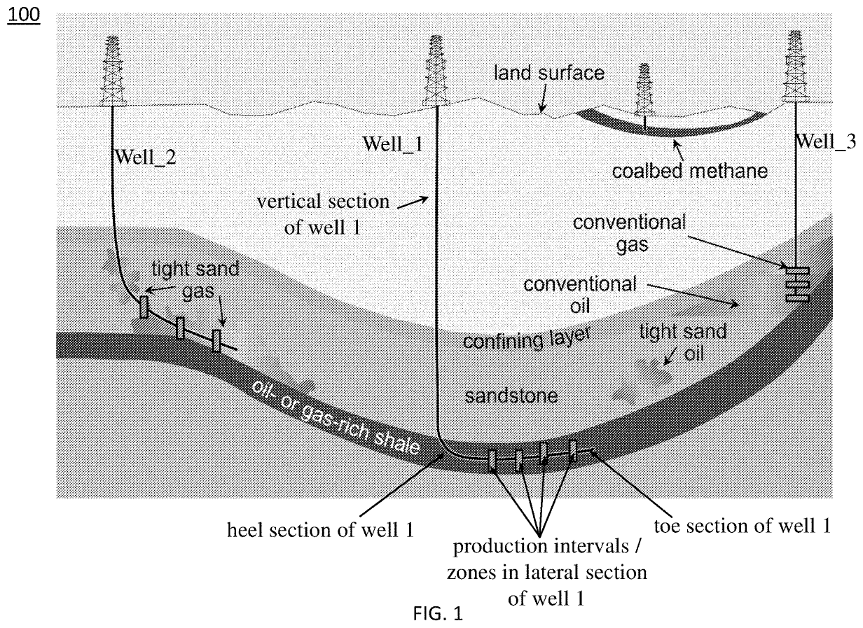

The mobile vessel described herein may be used in a number of settings, an example of which is depicted in FIG. 1, which illustrates a cross sectional view of an example oil production field (100), comprising one or more drilled wells (Well_1, Well_2, . . . ) for production and extraction of oil and/or gas from various regions of the field. In particular, as can be seen in FIG. 1, a vertical section of the Well_1 may be drilled to reach and penetrate an oil- or gas-rich shale (e.g., rock formation), and a lateral (e.g., horizontal) section of the Well_1, which, in the example case of FIG. 1 is substantially horizontal, may be drilled along the shale, starting from a heel section of the Well_1, and ending at a toe section of the Well_1. Generally, the vertical section of the Well_1 may extend 1 to 3 km below the surface and the lateral section of the Well_1 may extend for distances of, for example, 2-3 km or more.

With continued reference to FIG. 1, fluid mixtures, including oil, water, and/or natural gas mixtures, may enter the Well_1, for example, through open-hole or a casing of the Well_1, at production perforated intervals/zones that may be formed in the lateral section of the Well_1. Each of such production intervals/zones may include holes and/or openings that extract the fluid from the shale and route into the casing of the Well_1. As shown in FIG. 1, the perforated intervals/production zones may be separated by distances of, for example, about 100 meters (e.g., about 300 feet), and between each of the intervals (or stages) there are several clusters of perforations with closer spacing in order to cover a lengthy lateral and extract more hydrocarbon from shale/tight formations. Since there are many production zones, the inflow contribution for each of the intervals (or zones or clusters), such as, for example, local pressure, temperature, flow rates, and composition, may vary due to inherent geology and the accuracy with which the lateral section of the Well_1 intersects the oil-bearing rock formations at the production zones.

As described above, collecting data at regions of the Well_1, for example close to each of the production zones, can help evaluate effectiveness of inflow contribution for each of the production zones and further help in optimizing production (e.g., by altering the perforation/completion design). The camera-based flow sensor according to the present disclosure, integrated with a mobile vessel as described herein, may be used to measure a flow velocity of the fluid in the lateral section of the Well_1, the flow velocity inferred by velocity of features detected and tracked by one or more cameras (e.g., imaging sensors) of the flow sensor. Because different fluids and different phases of a fluid may include different absorption spectra, sensing of the flow may be based on information provided by other sensors that are placed inside of the lateral section of the well. Data sensed by such other sensors may include data related to, for example, pressure, temperature and composition (e.g., fraction of oil, gas, water). Furthermore, derivation of an effective fluid velocity based on velocity of the features detected and tracked by the camera-based flow sensor, may be based on a calibration routine that further takes into account any perturbation of the flow of the fluid in a region of the field of view of the camera-based sensor. For example, such calibration routine may consider flow restriction (e.g., variation of an effective cross-sectional area for the flow of the fluid) in a region of the field of view of the camera that may result in a higher velocity of the detected features.

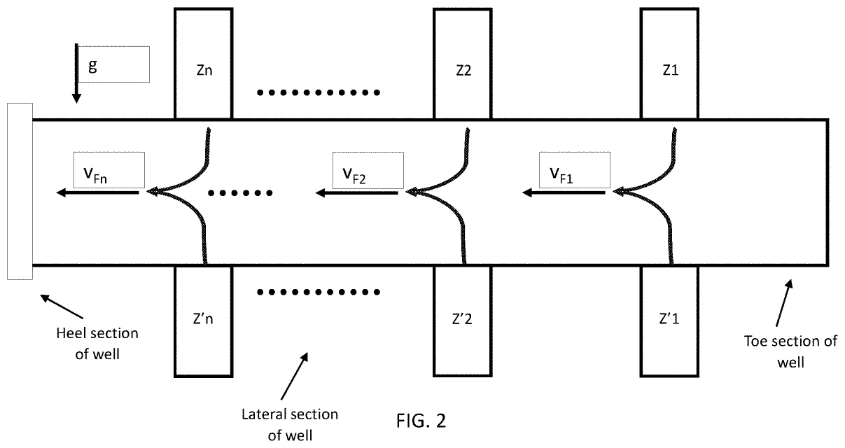

FIG. 2 shows a lateral section of a well of the oil production field shown in FIG. 1 comprising a plurality of production zones indicated as (Z1, Z′1, . . . , Zn, Z′n). Also shown in FIG. 2 are local fluid velocity vectors (V_{F1}, . . . , V_{Fn}) at vicinity of respective production zones. For example, the fluid velocity vector V_{F1}, may be considered solely based on an inflow (of fluid) contribution by the last production zone (Z1, Z′1) close to the toe section of the well. On the other hand, the fluid velocity vector V_{F2} may be considered based on a combination of the inflow contribution of the production zone (Z2, Z′2) combined with the inflow contribution of the last production zone (Z1, Z′ 1). In other words, a magnitude of the fluid velocity vector (V_{F1}, V_{F2}, . . . , V_{Fn}) along the lateral section of the well shown in FIG. 2 may be considered as an incremental magnitude with increments based on inflows provided by the respective production zones (Z1, Z′1, . . . , Zn, Z′n). Accordingly, a performance of each of the production zones (Z1, Z′1, . . . , Zn, Z′n) based on a corresponding inflow contribution may be assessed by measuring a difference between a magnitude of a fluid velocity vector before and after each production zone. For example, a difference between a magnitude of V_{F2} and a magnitude of V_{F1} may indicate an inflow performance of the production zone (Z2, Z′2).

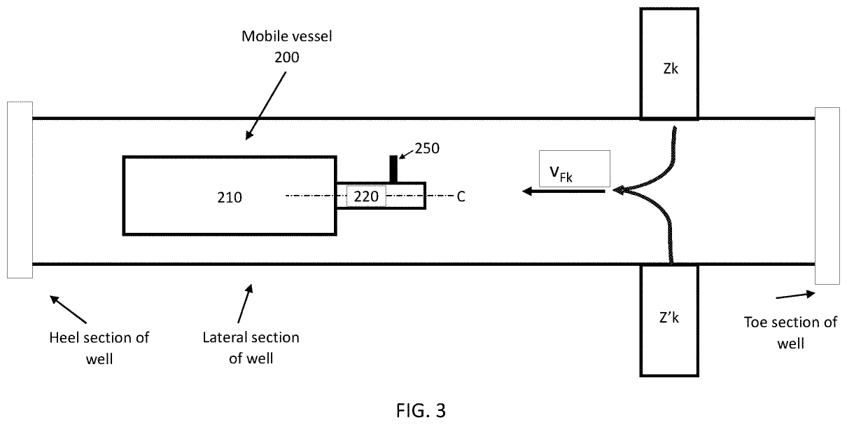

When integrated with a mobile vessel, such as a mobile robot, the camera-based flow sensor according to the present disclosure may be used to measure the magnitude of the local fluid velocity vectors (V_{F1}, . . . , V_{Fn}). This is shown in FIG. 3, where the mobile vessel (200), including for example an element (210) and an element (220), fitted with the camera-based flow sensor (250) according to the present teachings is positioned downstream (e.g., towards the heel section of the well) of the production zone (Zk, Z′k) for measurement of a magnitude of the local fluid velocity vector V_{Fk}. In this case, the mobile vessel (200) may be controlled to remain stationary during the gathering/sensing of corresponding measurement data and move to a next production zone for a next measurement. In some embodiments, actual derivation of the magnitude of the local fluid velocity vector may be performed either in real-time or non-real-time based on data sensed by the camera-based flow sensor (250) which may be combined with data sensed by other sensors as described above. It should be noted that the term “data” as used herein may relate to an ensemble of data values representative of signals gathered/sensed by one or more sensors of, for example, the camera-based flow sensor of the present teachings. Such data may be stored on local or remote memory for immediate or future use. In the particular case of the camera-based flow sensor of the present teachings, such data may include entire image frames, including for example, corresponding pixel data. Other data may include, for example, image frame rate and/or injection time and detection time of the quantum dots for derivation of corresponding time-of-flight.

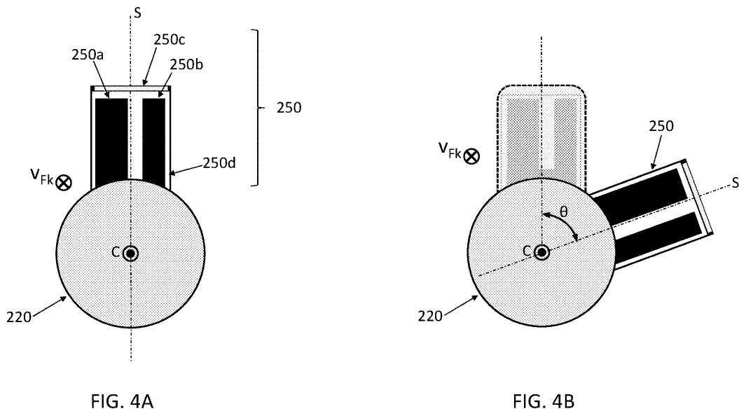

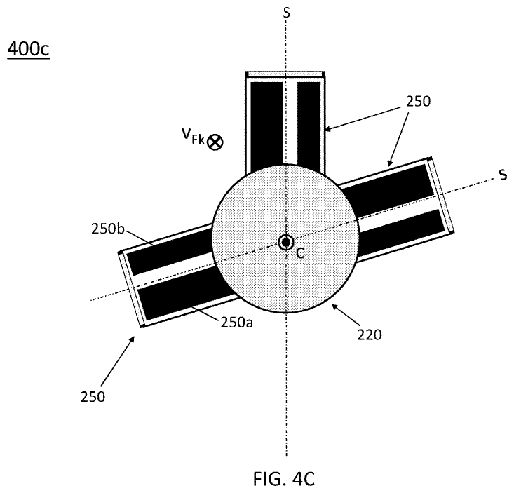

FIG. 4A shows a front view of the vessel of FIG. 3 with the camera-based flow sensor (250) positioned at a first angular position about a center axis, C, of the element (220, e.g., nose) of the mobile vessel (200) shown in FIG. 3. The center axis C may be a common axis of the elements (210) and (220) of the mobile vessel (200) as shown in FIG. 3, or may be an axis that is different from (e.g., parallel to) a center axis of the element (210, e.g., main body) of the mobile vessel. According to some example embodiments, the elements (210) and (220) of the mobile vessel (e.g., 200 of FIG. 3) may include a tubular or cylindrical shape about the center axis C, or about a respective center axis. Also shown in FIG. 4A is a direction of the local fluid velocity vector V_{Fk} which in the example configuration of FIG. 4A is assumed (substantially) parallel to an axial direction of the lateral portion of the well, as also shown in FIG. 3.

According to an embodiment of the present disclosure, the camera-based flow sensor (250) of FIG. 4A comprises a camera system (250a) that may include visible and infrared imaging sensors (250a), and an illuminator system (250b) that may include one or more illuminators (250b) that emit light at wavelengths detectable by the imaging sensors. The camera system (250a) and the illuminator system (250b) may be enclosed in an enclosure/housing (250d) that protrudes the element (220) of the mobile vessel and protects (along with element 250c later described) the elements (250a, 250b) against the outside environment (e.g., well environment). According to a nonlimiting embodiment of the present disclosure, the enclosure (250d) may include an axis of symmetry, S, that as shown in FIG. 4A may pass through the center axis, C, of the element (220). According to a nonlimiting embodiment of the present disclosure, a shape of the enclosure (250d) may be cylindrical so to reduce perturbation of the fluid at vicinity of the camera-based flow sensor (250). Other shapes, including shapes about the axis of symmetry, S, may be envisioned, with a corresponding perturbation of the flow factored in a calibration routine used to determine an effective velocity of the flow.

As shown in FIG. 4A, at an outer radial position (e.g., referenced to the center axis, C), the enclosure (250d) may include a window (250c, aperture) for transmission and/or detection of light from/by the camera system (250a) and/or the illuminator system (250b). As described above, the combination of the enclosure (250d) and the windows (250c) provide an interior space for the camera system (250a) and the illuminator system (250b) that is sealed and protected from the downhole environment. According to an example embodiment of the present disclosure, the window (250c) may be fabricated from sapphire. It is presently recognized that transparency of sapphire in the visible and in the near infrared spectrum, as well as its hardness and toughness, make sapphire suitable for operation of the camera-based flow sensor (250) according to the present disclosure in harsh environments, including in a lateral section of an oil well (e.g., Well_1 of FIG. 1).

According to an embodiment of the present disclosure, each of the one or more illuminators of the illuminator system (250b) may be light emitting diodes (LEDs) configured to emit a high-brightness light in the visible or the near infrared spectrum. According to a nonlimiting embodiment, such high-brightness light may include spectrally narrow light. As used herein, the expression “spectrally narrow” refers to a spectral content at full-width at half-maximum bandwidth in a wavelength range from 20 to 100 nm. According to an example embodiment of the present disclosure, a near infrared super-luminescent light emitting diode (NIR SLED) known to a person skilled in the art may be used as an infrared illuminator of the illuminator system (250b). According to a nonlimiting embodiment, the infrared illuminator may emit light at a wavelength between 1500 nm and 1700 nm, e.g. about 1600 nm.

According to an example embodiment of the present disclosure, a visible super-luminescent light emitting diode (visible SLED) known to a person skilled in the art may be used as a visible illuminator of the illuminator system (250b). According to a nonlimiting embodiment, the visible illuminator may emit light at any wavelength of the visible spectrum, including at wavelength corresponding to red, green or blue colors. As described above, the infrared illuminator of the illuminator system (250b) may be used for detection of features in oil. On the other hand, the visible illuminator of the illuminator system (250b) may be used for detection of features in phases other than oil (e.g., water, gas).

In some cases, it may be advantageous to measure the local fluid velocity vector V_{FK} at different angular positions about the center axis C of the element (220) for derivation of an angular profile of the flow rate. It follows that according to an example embodiment of the present disclosure and as shown in FIG. 4B, the camera-based flow sensor (250) may rotate about the center axis C of the element (220). For example, FIG. 4B shows the sensor (250), and therefore the camera system (250a) and the illuminator system (250b), at an angular position that is different by an angle θ from the angular position of the sensor (250) shown in FIG. 4A. Such rotation of the sensor (250) about the center axis C may be considered as a rotation in the azimuth direction of the lateral portion of the well which therefore allows derivation of azimuthal profiles of the flow rate.

With continued reference to FIG. 4B, according to an example embodiment of the present disclosure, the rotation of the camera-based sensor (250) may be based on a rotation of the element (220) to which the sensor (250) is rigidly coupled. In such configuration, the element (220), which may be referred to as a nose of the mobile vessel (200 of FIG. 3), may be a rotating part of the mobile vessel. Rotation of the nose (220) may be dependent on or independent from a rotation of the vessel itself (e.g., 210 and 220 rotating in unison). The nose (220) may rotate clockwise and/or counterclockwise to achieve a desired angular position of the camera-based sensor (250).

FIG. 4C shows a configuration (400c) of a camera-based flow sensor (400c) according to an embodiment of the present disclosure for simultaneous measurement of flow rate at a plurality of angular positions. Measurement of the flow rate at each of the plurality of angular positions is provided by a camera-based flow sensor similar to the camera-based flow sensor (250) described above with reference to FIGS. 4A and 4B. As can be seen in FIG. 4C, each of the (radial) camera-based flow sensors (250) is positioned (e.g., fixed) at a different angular position. Although the example configuration (400c) of FIG. 4C shows three flow sensors (250) arranged at different angular positions, in quadrature, other configurations including more or less flow sensors (250) arranged at different angular positions may be envisioned, including, for example, four flow sensors (250) arranged in quadrature. The configuration shown in FIG. 4C may allow simultaneous measurement of flow rate at a plurality of angular positions without requiring any of the flow sensors (250) to rotate about the center axis C. If desired, more flexibility (e.g., more angular data points) in measurement may be provided by (e.g., independently or in unison) rotating the flow sensors (250) in a fashion similar to one described above with reference to FIG. 4B (e.g., rotation of nose 220).

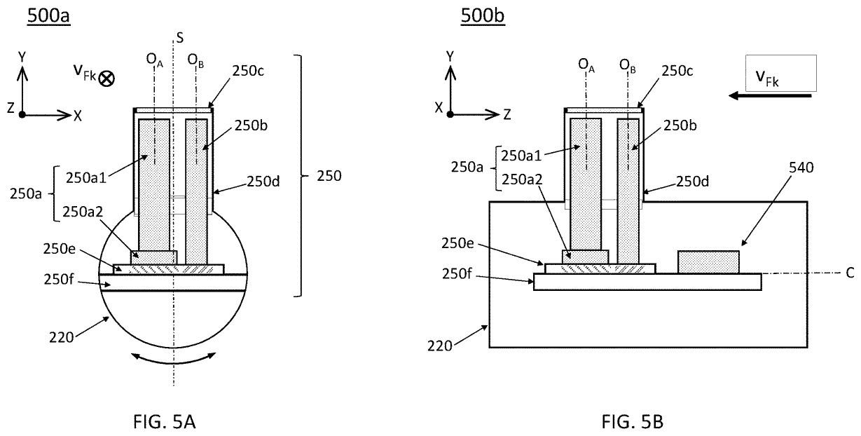

FIG. 5A shows details of a cross sectional front view (500a) of the camera-based flow sensor (250) according to an embodiment of the present disclosure. As shown in FIG. 5A, such cross sectional view (500a) is in a plane (x, y) that is orthogonal to the center axis, C (not shown in FIG. 5A for clarity purposes). As shown in FIG. 5A, the camera-based flow sensor (250) may further include a support platform (e.g., base 250f) used for mounting/fixating elements (e.g., 250a, 250b, 250c, 250d, 250e) into one sensor assembly that may be rigidly fixated/connected to the element (220) of the mobile vessel (e.g., shown in FIG. 3). Further included in the camera-based flow sensor (250) may be a thermoelectric cooler (250e) mounted on, and in contact with, the support platform (250f). In turn, the camera system (250a) and of the illuminator system (250b) may be mounted on, and in contact with, the thermoelectric cooler (250e).

According to an embodiment of the present disclosure, the thermoelectric cooler (250e) may be used to control temperature of camera system (250a) and of the illuminator system (250b) for operation in high temperature conditions as provided in the downhole of a well. According to an embodiment of the present disclosure, the thermoelectric cooler (250e) may control (cool down) (e.g., different hashed line patterns indicating different temperature control regions/zones of element 250e in FIG. 5A) from the temperature of the illuminator system (250b) to allow each of the systems (250a) and (250b) to operate within their respective safe and stable temperature ranges. Furthermore, if desired, the thermoelectric cooler (250e) may control temperature of respective visible or infrared elements of the camera system (250a) and the illuminator system (250b) independently (e.g., infrared camera independently from visible camera, and infrared illuminator independently from visible illuminator).

With continued reference to FIG. 5A, according to an embodiment of the present disclosure, a sensing sequence using the camera-based sensor (250) may include the steps: i) determination of operation/sensing according to visible spectrum, infrared spectrum, or both, including both in a sequence (e.g., multiplexing) or both simultaneously; ii) based on the determination according to i), activating of the thermoelectric cooler (250e) to control the temperature of respective visible and/or infrared elements of the camera system (250a) and/or the illuminator system (250b) to within operating ranges; iii) once operating ranges of the temperatures are obtained, based on the determination according to i), activate the visible and/or infrared elements of the illuminator system (250b) thereby emitting (constant power) light through the window (250c) into the fluid mixture; and iv) activate the visible and/or infrared elements of the camera system (250a) thereby receiving and capturing images of features in the fluid mixture for completion of the sensing sequence.

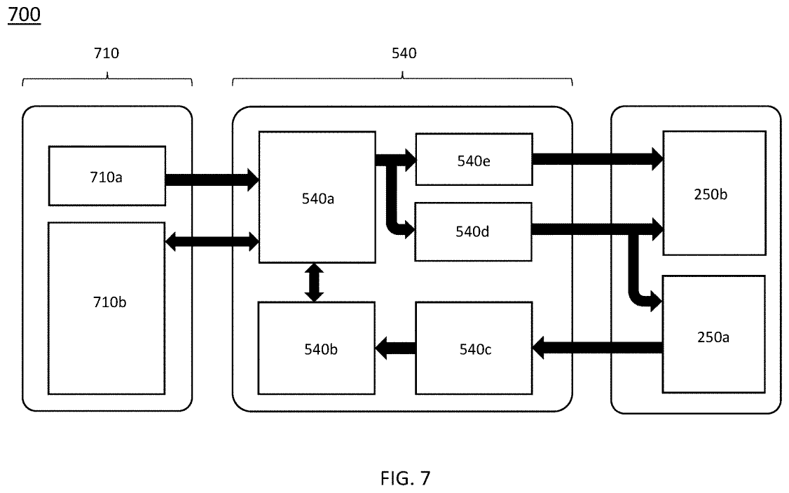

Captured image data (e.g., pixels) from the above sensing sequence may be processed to determine a velocity of the features and deduce a velocity of the fluid based on the velocity of the features. Such sensing sequence may be performed via a sensor electronic block (e.g., 540 of FIG. 5B later described with further reference to FIG. 7) that may be local (e.g., part of) to the sensor (250). Processing of the captured image data may be performed within same sensor electronic block, or by a different electronic/processing block that may be part of the mobile vessel (e.g., 200 of FIG. 3) or located outside the mobile vessel. It should be noted that the above sensing sequence may be adapted for operation in the transmissive mode using the above described quantum dot illuminators. This may include (simultaneous) injecting of one or more quantum dot illuminators (e.g., a group of quantum dot illuminators or a quantum dot illuminator group), and recording a corresponding time of injection which can be used, along with a time of detection of a frame that includes the injected one or more quantum dot illuminators or group of quantum dot illuminators, the time-of-flight.

With continued reference to FIG. 5A, as described earlier, each of the camera system (250a) and the illuminator system (250b) may include respective functionalities for operation/sensing in the visible spectrum and/or in the (near) infrared spectrum. For example, the camera system (250) may include a visible camera and an infrared camera schematically shown in FIG. 5A as element (250a) having an optical axis O_{A}, and a visible illuminator and an infrared illuminator schematically shown in FIG. 5A as element (250b) having an optical axis O_{B}, wherein O_{A} and O_{B} may be parallel with respect to one another, and substantially orthogonal to the plane defining the window (250c plane x, z)). It should be noted that although the optical axis O_{A} and O_{B} shown in FIG. 5A represents the optical axis for the visible/infrared cameras and the visible/infrared illuminators, such configuration should not be considered as limiting the scope of the present disclosure, as other configurations with separate/different optical axes for each of one or more cameras of the camera system (250a) and of one or more illuminators of the illuminator system (250a) may be envisioned based on the present teachings.

With further reference to FIG. 5A, according to an example embodiment of the present disclosure, the camera system (250a) may include a dual visible-infrared imaging sensor and related electronics (250a2) which in combination with a corresponding optical path (250a1), defined by the optical axis O_{A}, can (selectively) operate over the visible and/or infrared spectrum. As known by a person skilled in the art, operation/performance of an imaging sensor may be quantified by its quantum efficiency response curve as a function of a wavelength. For example, FIG. 6 shows a graph representative of a performance of an example CMOS imaging sensor that may be used as a visible imaging sensor in the camera-based flow sensor according to the present disclosure. As shown in the graph of FIG. 6, for a (visible) wavelength range between about 450 nm and 750 nm, the imaging sensor exhibits a quantum efficiency that is equal to, or higher than, 50%. In other words, for such wavelength range, the sensor may convert a fraction higher than 50% of the light (photon) energy received by the sensor into electrical energy. A similar quantum efficiency performance in an infrared wavelength range may be provided for an infrared imaging sensor that may be used in the camera-based flow sensor according to the present disclosure. It should be noted that although a quantum efficiency performance of at least 50% may be desirable, such value of the performance may not be considered as limiting the scope of the present disclosure, as lower values (e.g., in a range from about 10% to 50%) of the quantum efficiency may be used at the expense of, for example, extra signal processing routines. Furthermore, in a case where both visible and infrared sensors are used simultaneously, a corresponding broader spectral range of the captured images may provide a higher resolution for detection of the features, and therefore, lower performance imaging sensors may be possible.

According to an example embodiment of the present disclosure, the illuminator system (250b) may include a dual visible-infrared illuminator (250b) that can operate to emit visible and/or infrared light through an optical path (250b) defined by the optical axis O_{B}. It should be noted that design techniques for configuring each of the elements (250a) and (250b) for dual visible and infrared operation are known in the art and not the subject of the present disclosure. A person skilled in the art will know of many such design techniques, with preferred implementations based on design goals and limitations, including, for example, cost, performance/resolution, and/or available physical space.

Relative positioning/arrangement of the camera system (250a) and the illuminator system (250b) of the camera-based flow sensor according to the present teachings may be a design choice and based on, for example, available space in the element (200) as well as respective size of the elements (250a) and (250b). According to a nonlimiting embodiment of the present disclosure, the two elements (250a) and (250b) may be positioned so that their respective optical axes O_{A} and O_{B} are distanced in the x-direction as shown in FIG. 5A. According to another nonlimiting embodiment, the two elements (250a) and (250b) may be positioned so that their respective optical axes O_{A} and O_{B} are distanced in the z-direction as shown in the cross sectional side view (500b) of FIG. 5B, the z-direction being orthogonal to the plane (x, y) of FIG. 5A, or in other words, the z-direction being parallel to the center axis, C.

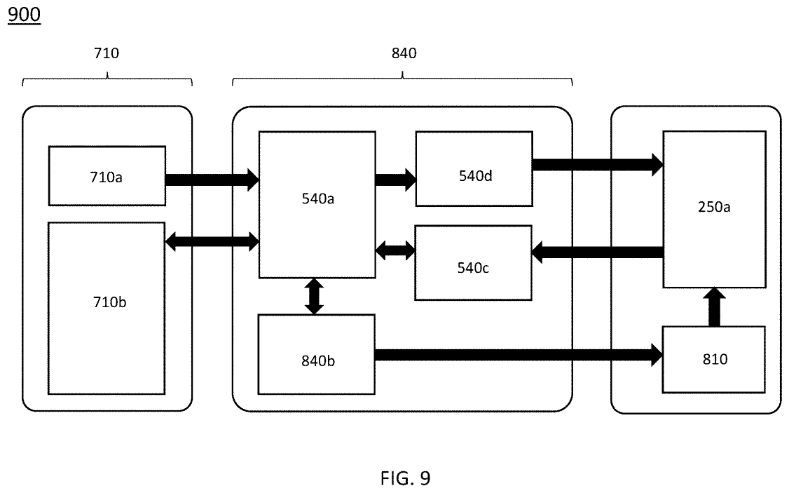

With further reference to cross sectional side view (500b) of FIG. 5B, the camera-based sensor (250) may further include a sensor electronic block (540) mounted on the support platform (250f). Optionally, the sensor electronic block (540) may be mounted on the thermoelectric cooler (250e) for (individual) control of its operating temperature in a manner similar (e.g., always activated) to the above described temperature control of elements (250a) and (250b). The sensor electronic block (540) may include functionality to perform the above described sensing sequence for either operation in the reflective or transmissive mode of operation of the camera-based flow sensor (250). Details of the sensor electronic block are provided below with reference to FIG. 7 for the reflective mode of operation, and with reference to FIG. 9 for the transmissive mode of operation.

FIG. 7 shows a block diagram (700) according to an embodiment of the present disclosure of the camera-based flow sensor described above with reference to FIG. 5A and FIG. 5B. As can be seen in FIG. 7, the block diagram (700) includes the sensor electronic block (540) described above with reference to FIG. 5B that is configured to control operation of, and receive and/or process data from, the camera system (250a) and the illuminator system (250b). A block (710) may interface with the sensor electronic block (540). According to an example embodiment, the block (710) may be part of the mobile vessel (e.g., 200 of FIG. 3) wherein the camera-based flow meter is integrated/mounted. According to another example embodiment, the block (710) may be part of the camera-based flow meter such as to provide a standalone sensor. It should be noted that the various blocks shown in the block diagram (700) may not necessarily be interpreted as related to physical distinct blocks/assemblies, rather representative of different functional blocks for operating the camera-based flow sensor according to the present disclosure. Accordingly, partitioning of such functional blocks into physical blocks/assemblies may be based on, for example, a method of use of the camera-based flow sensor.

With continued reference to FIG. 7, the block (710) may include a power supply block (710a) for provision of power to the block (540), and a data storage/interface block (710b) that may be used to store data captured/generated by the blocks (250a, 250b, 540), including for example, measured flow rates/velocities and related metadata. According to an example embodiment of the present disclosure, the metadata may include, for example, one or more captured images related to a flow velocity measurement; time stamps of the captured images; and positional data, including axial position relative to a length of the downhole and azimuthal position (e.g., angular position of the camera-based flow sensor). Other data and/or metadata may be included depending on a configuration of the camera-based sensor (e.g., single/multiple flow sensors, reflective/transmissive mode of operation). According to an example embodiment, the data storage/interface block (710b) may be used by the sensor electronic block (540) to gather information on phases present in the fluid mixture at the time of the flow/velocity measurement. As noted above, the camera-based flow sensor according to the present disclosure may use information sensed/gathered by other type of sensors (e.g., temperature, pressure, composition), which may be provided via the data storage/interface block (710b).

With further reference to FIG. 7, according to an embodiment of the present disclosure, the sensor electronic block (540) may include a microcontroller block (540a, e.g., implemented via any device known to a person skilled in the art, including a microprocessor and/or a field programmable gate array FPGA), an image processing block (540b), a camera electronic block (540c), a temperature control block (540d) and an illuminator control block (540e). According to an example embodiment of the present disclosure, the microcontroller block (540a) may be configured to synchronize all tasks related to the sensing sequence (e.g. steps i) to iv)) described above with reference to FIG. 5A by controlling, for example, operation of each of the blocks (540b, 540c, 540d, 540e). For example, the microcontroller block (540a) may optionally interface with block (710b) to determine phases of fluid present and accordingly determining operation/sensing according to visible spectrum, infrared spectrum, or both; activate the thermoelectric cooler (e.g., 250f of FIGS. 5A-5B) via the temperature control block (540d); activate the visible and/or infrared illuminator (e.g., 250b) via the illuminator control block (540e); and activate/select processing of images in the visible and/or infrared spectrum captured by the camera (e.g., 250a) via the image processing block (540b). It should be noted that under control of the sensor electronic block (540), a plurality of velocity measurements may be performed using the camera-based flow sensor according to the present teachings without input/output from/to the data storage/interface block (710b). In other words, a plurality of (uncalibrated) velocity measurements may be performed and then provided, along with corresponding time stamps, to the block (710b) for calibration and interpretation based on known position/orientation of the sensor by the block (710b) at the corresponding time stamps.

Although not shown in FIG. 7, in some embodiments of the present disclosure, the microcontroller block (540a) may directly interface with the camera system (250a) and/or corresponding camera electronic block (540c) to activate operation of the camera system according to the visible and/or infrared spectrum, and/or to control other related tasks (e.g., FIG. 9 later described).

According to an embodiment of the present disclosure, the camera electronic block (540c) may process each pixel in a corresponding visible/infrared imaging sensor of the camera system (250a), including intensity acquisition of each pixel, and send processed pixel data to the image processing block (540b). In turn, the image processing block (540b) may format/arrange the processed pixel data into separate image frames and process/analyze each of the separate image frames for detection of one or more features and relative movement of such features from one frame to the other. Based on the relative movement of features detected in the image frames, the image processing block (540b) may deduce a velocity of the features and therefore a measurement of the velocity of the flow, and provide such measurement (e.g., optionally along with above described metadata) to the microcontroller block (540a). It should be noted that video/image processing techniques for detecting of features and tracking of such features from frame to frame are known in the art and not the subject of the present disclosure. A person skilled in the art will know of many such video/image processing techniques, with preferred implementations based on design goals and limitations, including, for example, cost, performance/resolution, and/or available processing speed.

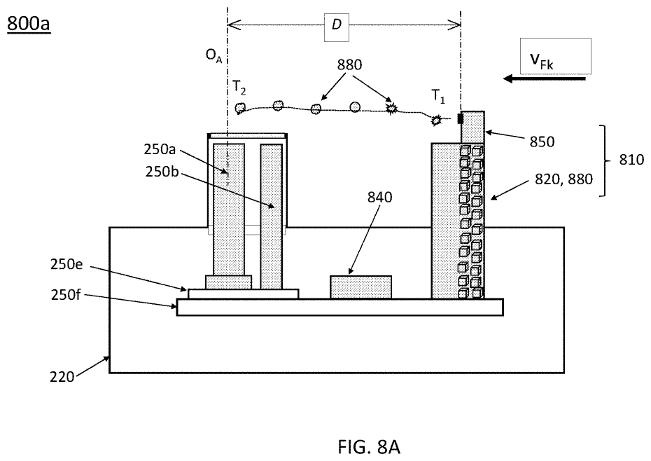

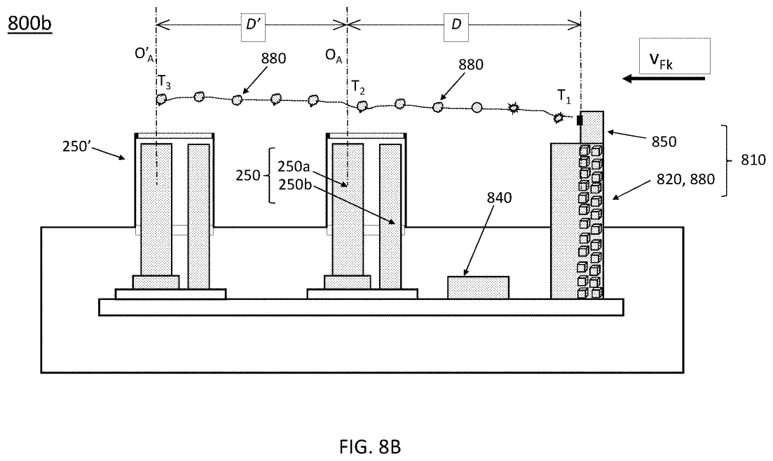

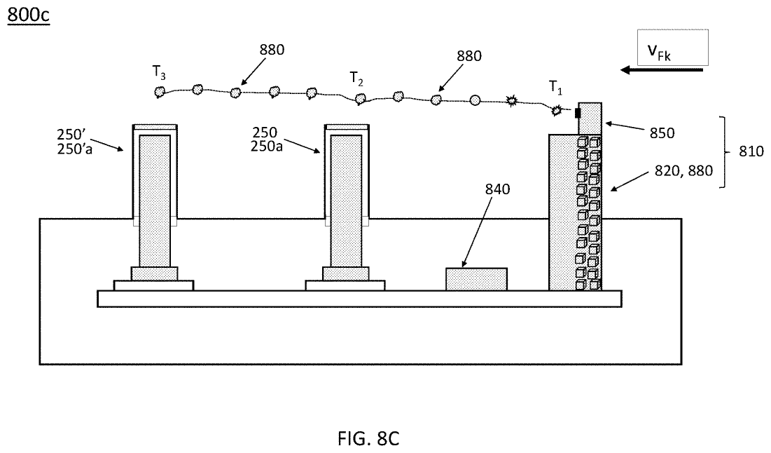

FIG. 8A shows details of a cross sectional side view (800a) of a camera-based flow sensor according to another embodiment of the present disclosure that is based on the camera-based flow sensor described above with reference to FIG. 5A and FIG. 5B, with additional capability to operate in the transmissive mode via injection into the fluid mixture of one or more quantum dot illuminators (880, e.g., as a group of quantum dot illuminators). As shown in FIG. 8A, the camera-based flow sensor includes a quantum dot illuminator system (810) that includes a storage compartment (820) for storage of the quantum dot illuminators (880), and an ejection/release mechanism/zone (850) that is configured to eject/release one or more quantum dot illuminators (880) from the storage compartment (820, reservoir), thereby injecting the one or more quantum dot illuminators (880) into the fluid mixture.

As shown in FIG. 8A, at a time T1, a quantum dot illuminator (880, e.g., as a group of quantum dot illuminators) is injected into the fluid mixture, which travels along with, and in the direction of, the local fluid velocity vector V_{Fk} towards the (position of the) field of view of the camera system (250a). At time T2, the quantum dot illuminator (880) reaches the (position of the) field of view of the camera system (250a) and is therefore detected/captured by the camera. A time-of-flight of the quantum dot illuminator (880) can be determined based on the time of travel (T2−T1), and the velocity of the quantum dot illuminator (880), and therefore of the fluid mixture, can be determined further based on a distance traveled (labeled as D in FIG. 8A) during the time-of-flight. As shown in the configuration (800b) of FIG. 8B, an increased accuracy of the velocity can be provided via provision of one or more additional camera systems (250a, included in the additional element 250′ of FIG. 8B). Such additional one or more camera systems (250a) may allow to calculate additional time-of-flights, such as for example, (T3-T2) to cover the distance D′, and (T3−T1) to cover the distance D+D′, which may be used to provide an averaged velocity of the quantum dot illuminator (880). It should be noted that as described above, the time-of-flight may be based on a single injected quantum dot illuminator (880), or a group/cluster of quantum dot illuminators (880) injected into the fluid mixture concurrently (at a same time).

The configurations (800a) and (800b) shown in FIG. 8A and FIG. 8B may allow operation of the camera-based flow sensor according to the reflective (illuminators' back-reflected light) and transmissive (quantum dot illuminators transmitted light) modes. According to an example embodiment of the present disclosure, as shown in FIG. 8C, the camera-based flow sensor may be configured for operation solely in the transmissive mode. FIG. 8C shows details of a cross sectional side view (800c) of a camera-based flow sensor according to another embodiment of the present disclosure that is configured for operation solely in the transmissive mode. A person skilled in the art will clearly realize that the configuration (800c) of FIG. 8C is based on the configuration (800b) described above with reference to FIG. 8B, but without the illuminator system (250b).

As described above, the quantum dot illuminator system (810) shown in FIGS. 8A, 8B and 8C may allow operation according to the transmissive mode. Accordingly, the sensor electronic block (840) shown in FIGS. 8A, 8B and 8C may include additional functionality to control/synchronize operation of the quantum dot illuminator system (810). This is shown in the block diagram (900) of FIG. 9, including an additional block (840b) which under control of the microcontroller block (540a) may control operation of the quantum dot illuminator system (810), including, preparing for ejection/release of one or more quantum dots (e.g., 880 of FIG. 8C) by controlling the block (810) to move the one or more quantum dots from the reservoir (e.g., 820 of FIG. 8C) to the ejection/release mechanism/zone (e.g., 850 of FIG. 8C); and to eject/release by controlling the block (810) to immediately (e.g., synchronous to a flag/timestamp) eject/release the one or more quantum dots through the ejection/release mechanism/zone. Furthermore, the camera electronic block (540c) may include further functionality to detect an increase in intensity acquired by one or more pixels and forward a corresponding flag to the microcontroller block (540a) as a detection event of a quantum dot illuminator. In turn the microcontroller block (540a) may calculate the time-of-flight of the detected quantum dot illuminator for further processing/calculation of the velocity (e.g., either by block 540a or through block 710b). It should be noted that the block diagram (900) includes functionality that support the transmissive mode of operation of the configuration shown in FIG. 8C. The same functionality may be added to the block diagram (700) described above with reference to FIG. 7 to support both the reflective and transmissive modes of operation of the configuration shown in FIG. 8A and FIG. 8B.

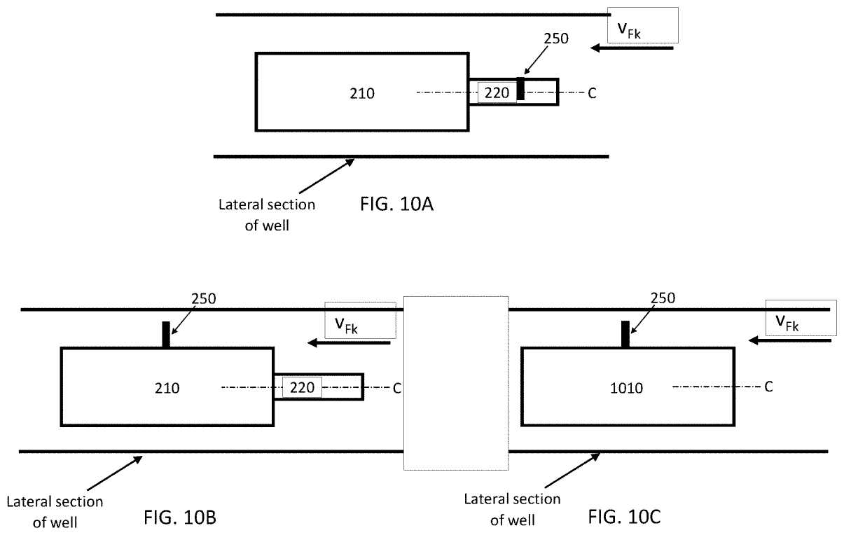

Protrusion of the camera-based flow sensor (e.g., 250 of FIG. 3) into the flow of the fluid mixture may cause undesired perturbations in the flow that may affect measurements/sensing performed by other sensors that may be integrated into the mobile vessel. It follows that according to an embodiment of the present disclosure the camera-based flow sensor may be retractable into the mobile vessel. This is shown in FIG. 10A, wherein the camera-based flow sensor (250) is shown retracted into a space within the nose (220) of the mobile vessel (200). In such configuration, the camera-based flow sensor (250) may remain in the retracted position so long flow velocity measurements are not performed. For measurement, the flow meter (250) may be extended outwards the nose (220) in a position as shown in FIG. 3.

It should be noted that the camera-based flow sensor of the present teachings may be mounted on any part of the mobile vessel (200), including the main body (210) as shown in FIG. 10B. In such configuration, a different calibration routine may be performed to derive the effective fluid velocity in view of a different flow restriction imposed in a region of the field of view of the camera. Furthermore, it should be noted that the camera-based flow sensor of the present teachings may be mounted on any mobile vessel configured for immersion in harsh environments such as, for example, a downhole of a well, including the lateral section of the well (e.g., lateral section of well_1 shown in FIG. 1). In other words, the mobile vessel may not necessarily be a mobile robot with advanced technologies. Rather, it can be a simple submersion vessel (1010) as shown in FIG. 10C fitted with the camera-based flow sensor (250).

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A system for gathering information about physical properties in a lateral section of a well, the system comprising:
a mobile vessel configured for submersion into a fluid mixture of the lateral section of the well; and
a camera-based flow sensor attached to the mobile vessel, the camera-based flow sensor comprising:
a camera system configured to capture images in a visible spectrum and in an infrared spectrum; and
an illuminator system configured to emit light in the visible spectrum and in the infrared spectrum,
wherein the camera-based flow sensor is configured to emit light into the fluid mixture and capture images of back-reflected light from features present in the fluid mixture.

2. The system according to claim 1, wherein:
an image captured by the camera-based flow sensor is based on activation of the illuminator system and the camera system for operation according to one of the visible spectrum or the infrared spectrum.

3. The system according to claim 1, wherein:
an image captured by the camera-based flow sensor is based on simultaneous activation of the illuminator system and the camera system for operation according to the visible spectrum and the infrared spectrum.

4. The system according to claim 1, wherein:
the images of back-reflected light from the features present in the fluid mixture comprises a sequence of consecutive images, and
the camera-based flow sensor determines a velocity of the fluid mixture based on relative movement of the features within the sequence of consecutive images.

5. The system according to claim 1, wherein the illuminator system comprises:
a visible light source that emits a spectrally narrow light in a wavelength range from 400 nm to 750 nm, and
an infrared light source that emits light in a near infrared wavelength range near 1600 nm.

6. The system according to claim 5, wherein:
the visible light source is a super-luminescent light emitting diode (SLED) with a spectral content at full-width at half-maximum bandwidth in a wavelength range from 10 nm to 100 nm.

7. The system according to claim 1, wherein:
the mobile vessel comprises a first element having a substantially tubular shape about a center axis, the first element configured to rotate about the center axis, and
the camera-based flow sensor includes an enclosure and a window that in combination provide a sealed interior space for protection of the camera system and the illuminator system, the enclosure and the window protruding from the first element.

8. The system according to claim 7, wherein:
the enclosure comprises a cylindrical shape that is radially attached to the first element.

9. The system according to claim 8, wherein:
respective optical axes of the camera system and the illuminator system are orthogonal to the center axis.

10. The system according to claim 1, wherein:
the camera-based flow sensor further comprises a thermoelectric cooler system configured to control a temperature of the camera system independently from a temperature of the illuminator system.

11. The system according to claim 1, wherein:
the camera-based flow sensor further comprises a quantum dot illuminator system configured to release one or more quantum dot illuminators into the fluid mixture, and
the camera-based flow sensor is further configured to capture a first image of light emitted from the one or more quantum dot illuminators.

12. The system according to claim 11, wherein:
the camera-based flow sensor determines a velocity of the fluid mixture based on a first time-of-flight of the one or more quantum dot illuminators, and
the first time-of-flight is based on
a distance between a release zone of the quantum dot illuminator system and a position of a field of view of the camera system, and
a time between the capture of the first image and the release of the one or more quantum dot illuminators.

13. The system according to claim 12, wherein:
the camera-based flow sensor further comprises an additional camera system, and
the camera-based flow sensor is further configured to capture, via the additional camera system, a second image of light emitted from the one or more quantum dot illuminators.

14. The system according to claim 13, wherein:
the camera-based flow sensor further determines the velocity of the fluid mixture based on a second time-of-flight of the one or more quantum dot illuminators,
the second time-of-flight is based on
a distance between the position of the field of view of the camera system and a position of a field of view of the additional camera system, and
a time between the capture of the second image and the capture of the first image.

15. The system according to claim 11, wherein:
the one or more quantum dot illuminators comprises particles or nanocrystals of a semiconducting material with diameters in a range from 2 nm to 10 nm.

16.-19. (canceled)

20. A camera-based flow sensor, comprising:
a camera system configured to capture images in a visible spectrum and in an infrared spectrum; and
an illuminator system configured to emit light in the visible spectrum and in the infrared spectrum,
wherein the camera-based flow sensor is configured to emit light into a fluid mixture and capture images of back-reflected light from features present in the fluid mixture.

21. (canceled)

22. A method for measuring a flow velocity of a fluid mixture, the method comprising:
emitting a light into the fluid mixture;
based on the emitting, capturing a sequence of consecutive images of back-reflected light from features present in the fluid mixture; and
based on the capturing, determining the flow velocity based on relative movement of the features within the sequence of consecutive images.

23. (canceled)
